(19) United States
(12) Patent Application Publication
(10) Pub. No.: US 2008/0066584 A1
(43) Pub. Date: Mar. 20, 2008

(54) MULTI-PURPOSE SOCKET TOOL

(76) Inventor: Richard Howell Vines, Myrtle Beach, SC (US)

Correspondence Address: B. CRAIG KILLOUGH, P. O. DRAWER H, CHARLESTON, SC, 29402, US

(21) Appl. No.: 11/936,381

(22) Filed: Nov. 7, 2007

Related U.S. Application Data
(63) Continuation-in-part of application No. 11/398,120, filed on Apr. 5, 2006.
(60) Provisional application No. 60/675,573, filed on Apr. 28, 2005.

(51) Int. Cl. B25B 13/00; B25B 13/06

(52) U.S. Cl. 81/124.2; 81/121.1

(57) ABSTRACT

A multi-purpose socket tool for loosening and tightening water inlet nuts used to connect pipes and tubing to toilet tank and wash basin faucet connections. The tool has an elongated body having a void through the body from a first end to a second end and forming a wall between the void and the outside of the body, and a longitudinal and continuous slit formed in the elongated body of sufficient width to accept a water inlet line. The first end is formed to accept a plurality of different types of water inlet nut and the second end is formed to accept a different type of water inlet nut. The second end of the socket tool may include an adapter to fit different sized nuts.

### CROSS-REFERENCE TO RELATED APPLICATIONS

This application is a continuation-in-part of Ser. No. 11/398,120 filed Apr. 5, 2006, which claims benefit of Provisional Patent Application Ser. No. 60/675,573 filed Apr. 28, 2005, on which the present application is based and benefit claimed under 35 U.S.C. §119(e), are incorporated herein by reference.

### BACKGROUND OF THE INVENTION

1. Field of the Invention

The present invention relates generally to tools, in particular socket tools. More specifically, the present invention related to a socket tool for loosening and tightening water inlet nuts used to connect pipes and tubing to toilet tank and wash basin connections.

2. Description of Related Art

Toilet tanks in common use are positioned to the rear of the toilet, and above the floor and against the wall on which the toilet is located. Wash basins are also normally positioned against a wall and above the floor. Most commonly, a water line extends upwardly, and continuously from the floor and a fitting connects the toilet or basin to the water line. The fitting is attached with a nut that surrounds the water line and is threaded onto the fitting. The nut is present on the outside of the toilet tank or basin, and contacts the bottom thereof.

Water inlet nuts in common use are primarily of two configurations. One configuration has a plurality of arcuate bosses formed about an outer circumference of the inlet nut. The other type of inlet nut has opposing blades that are formed 180° apart, and are positioned about the circumference of the water inlet nut.

When connecting or disconnecting the water line to a toilet tank or water basin the space is usually confined and the water line restricts the ability of the installer to move laterally. That confinement and restriction on lateral movement makes difficult the use of a standard open-ended pipe wrench to loosen or tighten the inlet nuts. The water line that extends continuously from the floor to the toilet tank or wash basin contributes to the difficulty in removing the inlet nuts. Therefore, there is a need for a multi-purpose socket tool for loosening and tightening connectors in places where there is limited access for a tool.

### SUMMARY OF THE INVENTION

It is an object of the present invention to provide to provide a multi-purpose socket tool for loosening and tightening connectors located in confined spaces.

There is provided a socket tool for loosening and tightening water inlet nuts. The multi-purpose socket tool has an elongated body having a generally circular void there through from a first end to a second end; thus, forming a wall between the void and the outside of the elongated body. The wall has a split formed therein of sufficient width to accept a water inlet line and extends continuously along the length of the elongated body from the first end to the second end.

The wall of said first end having a first configuration having a pair of slots formed therein positioned in said wall 180 degrees from each other for receiving a first species of water inlet nut having two blades formed about and protruding from a circumference of said first species of water inlet nut, wherein said wall.

The wall of the first end also has a second configuration having arcuate slots formed therein for receiving a water inlet nut having at least six arcuate bosses formed about and protruding from a circumference of the second species of water inlet nut, wherein the arcuate slots are equidistant from each other around said wall of the first end.

The wall of the second end has a hexagonal configuration sized to fit a specie of water inlet nut having such configuration. In addition, a hexagon shaped adapter may be provided that fits into the hexagon shape of the second end and sized to fit a different size nut.

### BRIEF DESCRIPTION OF THE DRAWINGS

Other objects, features and advantages of the present invention will become apparent from the following detailed description of the invention taken in conjunction with the accompanying drawings.

FIG. 1A illustrates the socket tool of the present invention positioned along the axis of a water line ready to engage one type of water inlet nut;

FIG. 1B illustrates the socket tool of the present invention positioned along the axis of a water line ready to engage another type of water inlet nut;

FIG. 2 is a perspective view of the socket tool of the present invention illustrating the configuration of the first end of the socket tool;

FIG. 3 shows a perspective view of the socket tool of the present invention illustrating the second end of the socket tool;

FIG. 4 is a plan view showing engagement of the socket tool of the present invention with one type of water inlet nut;

FIG. 5 is a plan view showing the socket tool of the present invention engaging another type of water inlet nut;

FIG. 6 shows a perspective view of the socket tool of the present invention illustrating the adapter used in the second end of the socket tool to provide for a different sized nut; and

FIG. 7 is a plan view showing the adapter engaged in the second end of the socket tool.

### DESCRIPTION OF THE PREFERRED EMBODIMENT

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be through and complete, and will fully convey the scope of the invention to those skilled in the art.

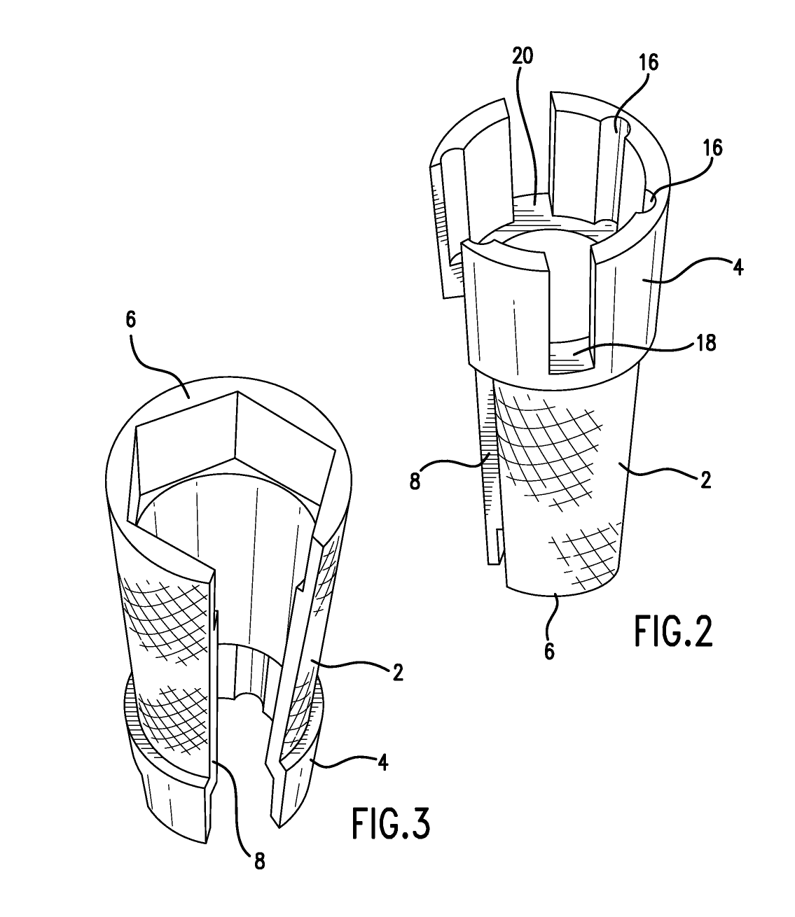

Referring now to the drawings and in particular FIG. 2 and FIG. 3, there is shown a preferred embodiment of the multi-purpose socket tool of the present invention. The socket tool has an elongated body 2 with a first end 4 and a second end 6. There is a void through the center of the elongated body 2 sufficiently large to accommodate a water line. The elongated body 2 of the socket tool has a generally circular outside diameter. The first end 4 has a generally circular void formed therein that is concentric with and is preferably enlarged relative to the remainder of the elongated body. A portion of the outside surface of the elongated body 2 may be knurled, so that it may be easily gripped, either by hand, or by a tool such as a pipe wrench. Flats may be formed in a surface of the device so that the socket tool may be gripped with a wrench.

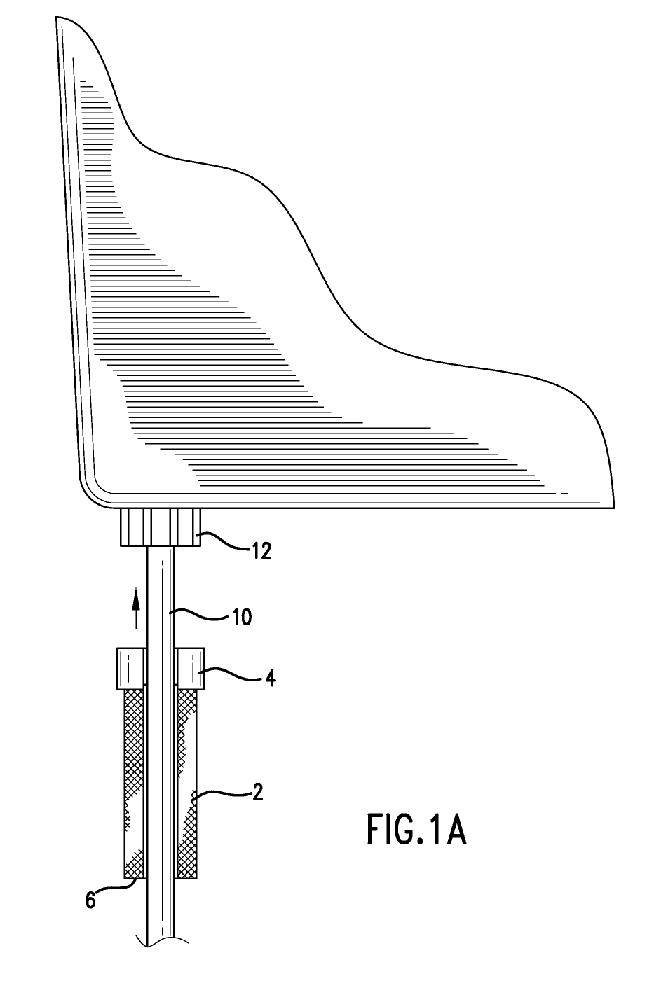

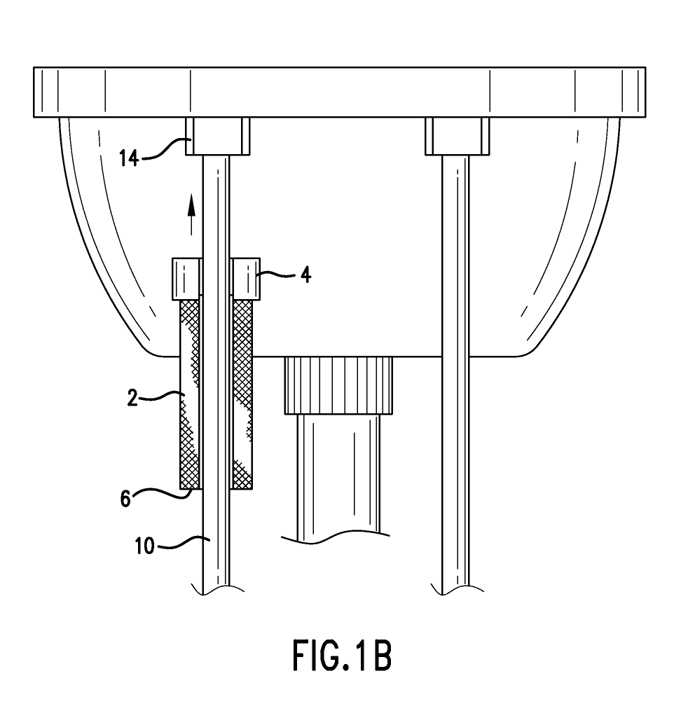

There is a longitudinal slit 8 formed in the elongated body 2 extending continuously along the length of the elongated body 2 from the first end 4 to the second end 6 of the socket tool. As shown in FIG. 1A and FIG. 1B, the split 8 allows the elongated body 2 of the socket tool to accept water inlet line 10 therein, so that the water inlet nut 12 or 14 may be manipulated by the socket tool without interference from the water line. As shown in FIG. 1A and FIG. 1B, the socket tool engages the water line below the water inlet nut 12 or 14, and the tool is then moved upwardly to engage the water inlet nut.

In a first embodiment, the wall of the first end 4 of elongated body 2 has a configuration to accept a first species of water inlet nut 14. This first species of water inlet nut 14 has two blades formed about and protruding from a circumference thereof. As shown in FIG. 5, the first end 4 of the socket tool has a wall surrounding a void in the elongated body 2, with the wall having a first slot 18 formed therein for receiving one of two blades formed on the water inlet nut 14 and a second slot 20 formed in the wall for receiving the remaining blade. The first slot 18 is positioned in the wall 180 degrees from the second slot 20. The slots 18, 20 engage the blades of the water inlet nut 14 to manipulate the water inlet nut and cause the water inlet nut 14 to engage the threaded fitting on the water inlet line 10 or to disengage from the fitting.

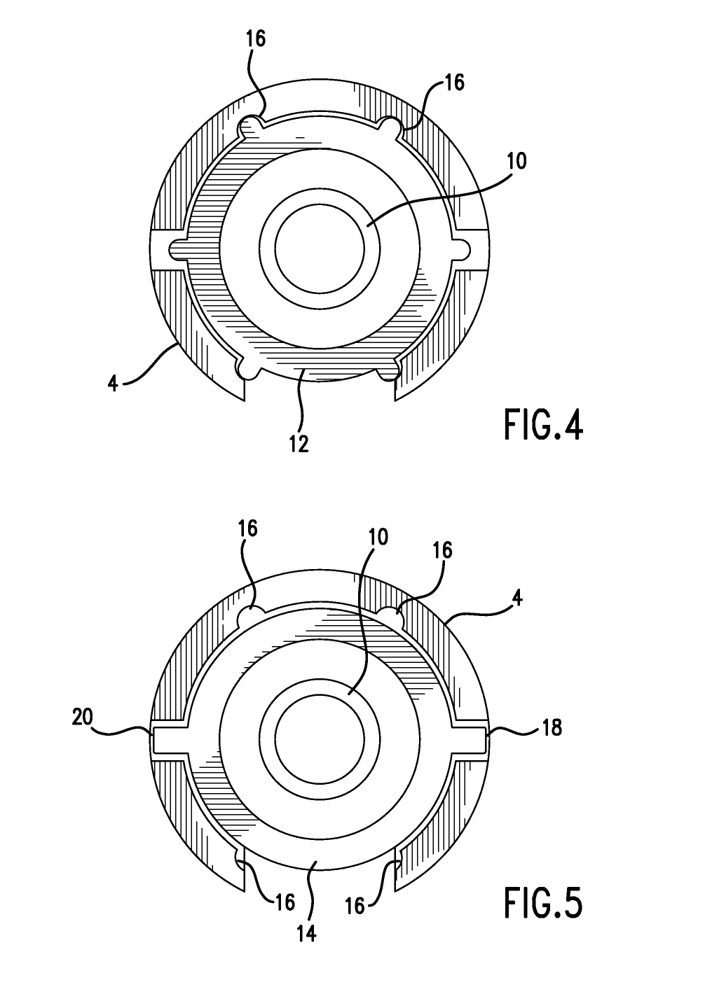

In a second embodiment, the first end 4 of the socket tool is also adapted to accept a second species of water inlet nut. The engagement of the socket tool with this second type of water inlet nut 12 is shown in FIG. 4. Water inlet nut 12 has a plurality of bosses, six in the example shown, formed about and protruding from the circumference thereof and engaging slots formed in the first end 4.

The wall of first end 4 has an arcuate slot formed therein for receiving each of the arcuate bosses. The arcuate slots are equidistant from each other. In the example shown in FIG. 4, two bosses are engaged in slots 18, and 20. Another two bosses are engaged in arcuate slots 16. The remaining two bosses are engages in half slots 16. The arcuate slots push against the bosses on the perimeter of the water inlet nut 12 to manipulate the water inlet nut, and cause the water inlet nut to engage the threaded fitting on the water inlet line, or to disengage the water inlet nut from the fitting. The slots 16-18 and 20 engage the blades of the water inlet nut 12 to manipulate the water inlet nut and cause the water inlet nut 12 to engage the threaded fitting on the water inlet line 10 or to disengage from the fitting.

In yet another embodiment, the socket tool may be used to loosen and tighten a third type of water inlet nut, i.e., a hexagonal shaped nut. As shown in FIG. 3 the wall of the second end 6 has a hexagonal configuration sized to fit the specie of water inlet nut of that configuration. The tool is positioned over the water inlet line 10, with the water inlet line traversing the length of the elongated body 12. FIG. 3 shows the tool of FIG. 2 inverted to reveal the second end 6.

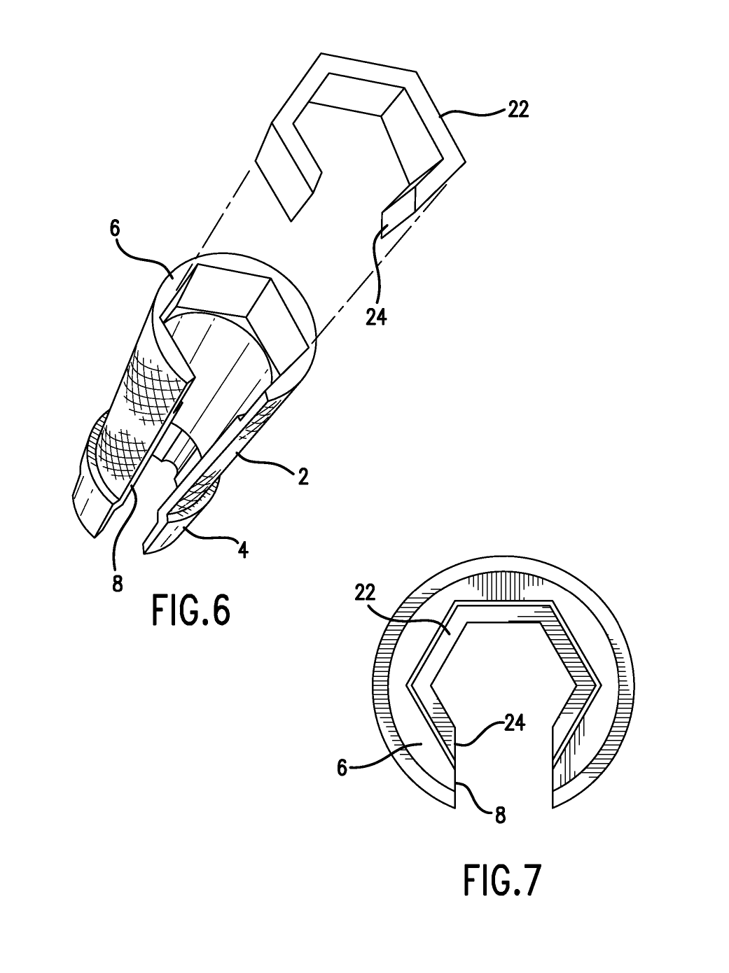

The hexagonal configuration of the second end 6 of the socket tool fits one size nut; however, other sized nuts may be used on water inlet lines. In such case an adapter 22 is provided that fits into the hexagonal shape of second end 6 as shown in FIG. 6. The outside dimensions of adapter 22 are such that the adapter fits smoothly into and engages the socket at the second end 6 as shown in FIG. 7. One side of the adapter forms a slit 24 approximately corresponding in width to slit 8 of the socket tool. The adapter 22 is placed in the end 6 of the socket tool with the slit aligned with slit 8 so that the water inlet line 10 is accepted therein. The inside of the adapter 22 is sized to fit a particular size nut. It should be understood that there may be several different sized adapters to fit a variety of nuts.

In use, it is first determined which type of water inlet nut is to be used on the toilet tank or wash basin, and the appropriate end of the socket tool is positioned to the top of the tool. The elongate body 12 engages the water line 10 through the slit 8 in the elongated body 12 of the socket tool, so that the water line 10 is contained within the void of hollow interior of the elongated body. The socket tool is first positioned below the water inlet nut, and is then moved upwardly so that the appropriate end of the socket tool engages the water inlet nut, as shown in FIG. 1A and FIG. 1B.

Once the socket tool is positioned over the water inlet nut as required by the type of water inlet nut to be manipulated, the tool may then be rotated manually, or with the aid of a wrench, to engage (tighten) or disengage (loosen) the water inlet nut. Most water inlet nuts are formed of plastic, and are not typically mounted with a great amount of torque. The knurled surface of the socket tool permits the nut to be attached or removed by gripping the tool with only one hand, and without using another tool, in most applications. Accordingly, the socket tool will quickly and easily remove water inlet nuts of multiple designs, without the necessity of using other tools. The design allows the device to be easily rotated for attaching or removing the water inlet nuts, without the water inlet line interfering with the manipulation of the water inlet nuts.

Many modifications and other embodiments of the inventions set forth herein will come to mind to one skilled in the art to which these inventions pertain having the benefit of the teachings presented in the foregoing descriptions. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A socket tool for loosening and tightening water inlet nuts comprising:
an elongated body having a void through said elongated body from a first end to a second end forming a wall between said void and the outside of said elongated body, said wall having a split formed therein of sufficient width to accept a water inlet line and extending continuously along the length of said elongated body from said first end to said second end;
said wall of said first end having a first configuration having a pair of slots formed therein positioned in said wall 180 degrees from each other for receiving a first species of water inlet nut having two blades formed about and protruding from a circumference of said first species of water inlet nut; and
wherein said wall of said first end also having a second configuration having arcuate slots formed therein for receiving a water inlet nut having at least six arcuate bosses formed about and protruding from a circumference of said second species of water inlet nut, wherein said arcuate slots are equidistant from each other around said wall of said first end.

2. The socket tool for loosening and tightening water inlet nuts according to claim 1, wherein said wall of said second end has a hexagonal configuration sized to fit a specie of water inlet nut of that configuration.

3. The socket tool for loosening and tightening water inlet nuts according to claim 1, wherein said arcuate slots are formed in an interior of said wall and do not extend to an exterior of said wall.

4. The socket tool for loosening and tightening water inlet nuts according to claim 1, wherein two of said arcuate slots each intersect said split in said elongated body.

5. The socket tool for loosening and tightening water inlet nuts according to claim 1, wherein said elongated body has a generally circular outside diameter.

6. The socket tool for loosening and tightening water inlet nuts according to claim 1, wherein said first end is enlarged relative to the remainder of said elongated body.

7. The socket tool for loosening and tightening water inlet nuts according to claim 1, wherein said void in said elongated body is a generally circular between said first end and said second end.

8. The socket tool for loosening and tightening water inlet nuts according to claim 2, further comprising an adapter having outside dimensions such that the adapter fits smoothly into and engages said second end of said socket tool and the inside of said adapter is sized to fit a particular size nut.

9. A socket tool for loosening and tightening water inlet nuts comprising:
an elongated body having a generally circular void through said elongated body from a first end to a second end forming a wall between said void and the outside of said elongated body, said wall having a split formed therein of sufficient width to accept a water inlet line and extending continuously along the length of said elongated body from said first end to said second end;
said wall of said first end having a first configuration having a pair of slots formed therein positioned in said wall 180 degrees from each other for receiving a first species of water inlet nut having two blades formed about and protruding from a circumference of said first species of water inlet nut, wherein said wall;
said wall of said first end also having a second configuration having arcuate slots formed therein for receiving a water inlet nut having at least six arcuate bosses formed about and protruding from a circumference of said second species of water inlet nut, wherein said arcuate slots are equidistant from each other around said wall of said first end; and
wherein said wall of said second end has a hexagonal configuration sized to fit a specie of water inlet nut of such configuration.

10. The socket tool for loosening and tightening water inlet nuts according to claim 9, further comprising an adapter having outside dimensions such that the adapter fits smoothly into and engages said second end of said socket tool and the inside of said adapter is sized to fit a particular size nut.
